(19) United States
(12) Patent Application Publication
(10) Pub. No.: US 2008/0203705 A1
(43) Pub. Date: Aug. 28, 2008

(54) Saddle Cart

(75) Inventor: Hans Zimmerer, Parkstein (DE)

Correspondence Address: LOWRIE, LANDO & ANASTASI, LLP, ONE MAIN STREET, SUITE 1100, CAMBRIDGE, MA, 02142, US

(73) Assignee: Karolin Zimmerer, Parkstein (DE)

(21) Appl. No.: 11/813,149

(22) PCT Filed: Dec. 28, 2005
(86) PCT No.: PCT/EP05/57193

§ 371 Date: Feb. 14, 2008

(30) Foreign Application Priority Data
Dec. 30, 2004 (DE) 10 2004 020 296.4
Sep. 26, 2005 (DE) 10 2005 045 962.5

(51) Int. Cl. B62B 1/26; B62B 1/12; B62B 1/14; B68C 1/00

(52) U.S. Cl. 280/654; 54/1

(57) ABSTRACT

A drivable saddle cart for storing and transporting saddles, bridles, and/or other equestrian equipment, wherein a frame with at least one saddle holder (15) is provided, which includes at least two wheels (3), so that the frame is drivable.

### TECHNICAL BACKGROUND

The present invention relates to a drivable saddle cart for storage and transportation of saddles, bridles, and/or other equestrian equipment.

Saddles, saddle blankets, cool down covers, bridles, halters, and similar have to be stored and stowed in a suitable manner after use. For this purpose, typically saddle holders are being used, on which the saddles can be placed. The other equipment is being stored without any specific differences at commonly known locations, like hooks, shelves, drawers, and similar.

Especially during tournaments, however, there is the problem, that very often no suitable storage options are available. This is especially unsatisfactory for the expensive items like tournament saddles, etc., since inadequate storage means can easily cause damage to these items.

### DISCLOSURE OF THE INVENTION

### Technical Object

Thus it is the object of the present invention to provide a storage option, which allows an orderly and appropriate storage, in particular of saddles, and additionally also of other equipment like saddle blankets, cool down covers, horse blankets, halters, bridles, and other equipment. In particular, easy transportation shall also be associated with such storage means, and additionally the storage means itself shall also be transportable, in order to be able to use it at different locations, like e.g. at tournaments. Overall, the device provided for this purpose shall be of simple construction and easy to operate.

### Technical Solution

This object is accomplished through a drivable saddle cart with the features of claim 1. Advantageous embodiments can be derived from the features of the dependent claims.

The present invention is characterized in that a frame is provided, which includes at least two wheels, so that the frame is drivable, wherein a suitable holder for holding a saddle is provided on the frame.

With such a device it becomes possible to store a saddle safely and appropriately, and simultaneously it becomes possible to transport the saddle from one place to another in a simple manner. This way, it also becomes possible to store the saddle at any location in a suitable manner. Preferably, the drivable saddle cart is equipped with two wheels, similar to a hand truck with two wheels, wherein at least one, preferably two supports are provided for parking, forming a support plane together with the two wheels.

In a further preferred embodiment, also the additional support, or the additional supports can be provided with one wheel each, so that a three-wheel or four-wheel setup ensues, which allows to drive the saddle cart and park it safely.

The saddle cart is preferably provided with a frame, similar to a hand truck, which includes a main component, extending vertically upward from the at least two wheels. However, the saddle holder is not provided at the lower end close to the wheels on the main component of the frame, but offset from the wheels in the upper section of the main component of the frame. The saddle holder is hereby disposed in an almost perpendicular direction to the main component of the frame, or at an angle to the frame, so that the saddle stored on the saddle holder is forced in the direction of the main component of the frame.

The saddle holder is hereby preferably disposed in the same direction, pointing away from the main component of the frame, like the additional supports. Compared to a hand truck, thus the function of its load surface is divided into a support function, through the supports, in addition to the at least two tires, and the holder function for the saddle, so that a U-shape of the drivable saddle cart ensues in contrast to the L-shape of the hand truck.

Besides a single saddle holder, also two or more saddle holders can be provided, in particular parallel to each other, or above each other, so that, for example, an E-shape is created with two saddle holders.

Preferably, also according to a preferred embodiment, a container for receiving equipment (equipment container) can be provided in the area of the wheels, which replaces the supports, or holds them. The equipment container preferably extends from the main component of the frame in the same direction, and is preferably provided parallel to the saddle holders.

The equipment container is preferably provided shaped as a tub from a frame design with perforated sheet metal cover.

At the upper end of the main section of the frame grips are disposed, in particular two laterally protruding stick grips, pointing in the opposite direction of the saddle holders, or of the equipment container, in order to be able to drive the saddle cart.

According to a particularly preferred embodiment, the saddle cart is provided collapsible, in order to assure easy transportation of the saddle cart, e.g. for tournament use. For this purpose, preferably the main component of the frame between the saddle holder or the saddle holders, on the one hand, and the equipment container and the wheels, on the other hand, is divided into a first upper frame component (carrier frame) and a second lower frame component (lower component), which can be pivoted or tilted relative to each other.

Additionally, preferably one or several saddle holders are also disposed pivotable and/or removable at the main frame component, wherein in particular a pivoting relative to the main component is possible in a manner, so that the saddle holder can be disposed substantially parallel to the main component or the first upper frame component (carrier frame). Accordingly, the saddle holder can be received after folding in a space, which is formed between the bottom of the equipment container and the carrier frame, this means the saddle holder or the saddle holders are being received in the equipment basket during transportation.

For a pivotable disposition of the first upper frame component (carrier frame) with reference to the lower frame section (lower frame), as well as the pivotable placement of the saddle holder or the saddle holders, relative to the carrier frame, all suitable rotating connections or joints can be used. It is possible, in particular, to provide simple threaded connections, pin and/or bolt assemblies, and similar.

Preferably, a locking bar is provided for arresting the upright position of the carrier frame, which can work with its locking plate in a friction locked manner, with a locking axle of the carrier frame. This way, through a simple operation, thus tilting the locking frame, which can also be performed by a foot, a locking of the carrier frame in the upright position, or an unlocking is possible.

If the tilting direction of the locking frame is preferably selected, so that the locking is performed through pressing down the locking frame, the locking frame can additionally be used in this way for operating the saddle cart, so that through the application of a load or a torque, relative to the axle of the wheels, e.g. through pressing with a foot, a rising or tilting of the saddle cart from the standing position becomes possible.

Preferably, also locking mechanisms for the unfolded state of the saddle holder and/or the folded state of the saddle cart are provided, wherein simple methods of securing through holder rings, fixated bolts or pins, as well as, elastic clamping, relative to holding pins and similar, are conceivable.

### SHORT DESCRIPTION OF THE DRAWINGS

Further benefits, characteristics, and features of the present invention become apparent in the subsequent detailed description of preferred embodiments with reference to the appended drawings. The figures hereby show in a schematic manner in:

FIG. 1 a perspective side view of a first embodiment of the saddle cart according to the invention;

FIG. 2 a perspective front view of the saddle cart of FIG. 1;

FIG. 3 a perspective rear view of the saddle cart of FIG. 1 and FIG. 2 in a folded state;

FIG. 4 a partial perspective side view of the saddle cart of FIGS. 1 through 3 in more detail;

FIG. 5 a perspective side view of a second embodiment of a saddle cart according to the invention;

FIG. 6 a perspective front view of a saddle cart of FIG. 5;

FIG. 7 a perspective rear view of the saddle cart of FIGS. 5 and 6; and in

FIG. 8 a perspective partial lateral view of the saddle cart of FIGS. 5 through 7 in more detail.

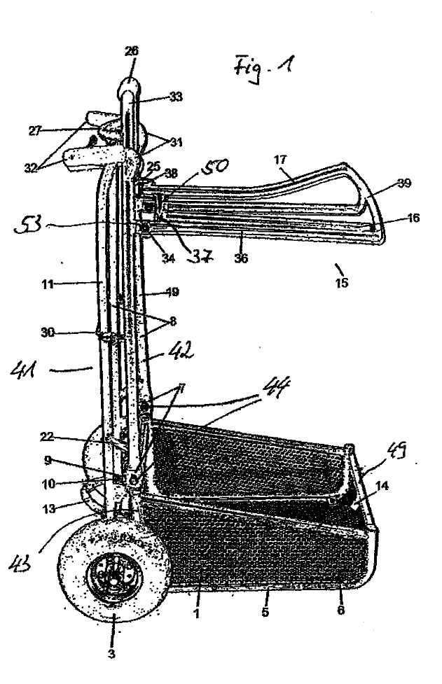

FIG. 1 shows a first preferred embodiment of a saddle cart including a saddle holder or support 15.

The saddle cart according to FIG. 1 includes a frame 41, comprising a main component 42, which is substantially oriented vertical in the drivable condition shown in FIG. 1. This main component 42 includes a first upper component shaped as a carrier frame 8, and a second lower component 43, both pivotable relative to each other around the rotating connections 44.

The entire frame 41, and in particular the main component 42, with the carrier frame 8 and the lower part 43, are created from a tubular frame assembly 5.

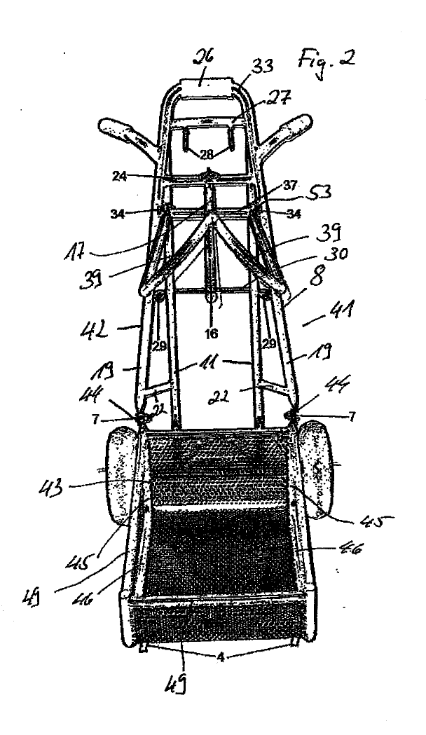

As it becomes apparent in particular from the additional FIGS. 2 through 4, the carrier frame 8 is formed as the upper part of the main component 42 by two main frames 19, pointing upwards and towards each other at an acute angle, and connected amongst each other through the uppermost lateral tube 33, which is bent in a semicircle. Furthermore, the main frames 19 are additionally connected amongst each other through a bent tubular frame 27, which protrudes almost vertically from the plane of the main frames 19. Furthermore, two ground supports 11 are provided at the carrier frame 8, which are connected to the main frames 19 via the tubular supports 22. The ground supports 11 are provided parallel to each other, and extend out of the plane of the main frames 19 through a curvature, respectively provided at the top, wherein they extend in parallel to the main frame for a substantial part of their longitudinal extension. This way the carrier frame 8 forms a trapezoid grid structure.

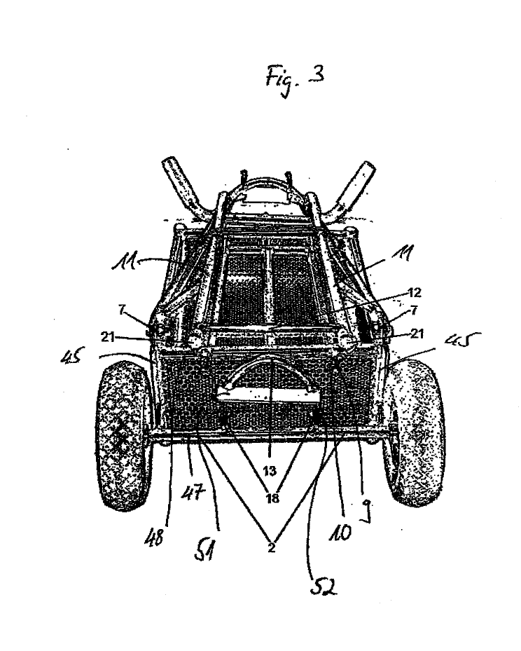

The lower section 43 of the main component 42 of the frame 41 is formed by two vertical tubular sections 45 and by an axle housing 47, connecting these tubular sections 45 with a lateral beam 48, extending in parallel to it (see FIGS. 2 and 3).

At the lower part 43 of the frame 41, an equipment container or equipment basket 1 is provided, whose framework 5 is partially provided through the vertical tube sections 45, and the lateral beam 48. In particular, as it is apparent from FIG. 2, the framework of the equipment basket 1 can be provided in a manner, so that the vertical tube sections 45 transition into the horizontal basket carriers 46 through respective bent tubes, which, in turn, are bent upward at their ends, so overall a tub shaped structure is created. The two U-shaped basket carriers 46, disposed in parallel to each other, have mutual connection beams 49, disposed at their respective ends, in order to form an overall approximately square tubular frame setup 5 for the tub shaped equipment container 1.

Perforated sheets 6 are used for filling the side walls, which are characterized by low weight, protected containment of the equipment and easy cleaning.

The carrier frame 8 of the frame 41 is pivotably connected via the rotating connections 44 to the lower part 43, wherein either the frame design of the carrier frame 8 at the main frames 19, and/or the vertical tubular sections 45 of the lower frame part 43 include flat mounting ears 7, which were created through squeezing, which are perforated for performing bolted connections or similar. This way, a secure rotating connection can be manufactured in a simple manner. Certainly also other joints or other rotating connections are conceivable.

At the carrier frame 8, a saddle holder or a saddle support 15 is provided in the shown embodiment of FIG. 1, which is provided pivotable relative to the carrier frame 8. Therein, perforated holders 34 are also provided, in which, similar to the rotating connections 44, respective threaded connections, pins, bolts, and similar are provided, similar to the rotating connections 44 between the carrier frames 8 and the lower body 43, for providing a joint or a rotating connection. In particular through the suitable choice of the respective connection means, a simple removal of the saddle support 15 can be accomplished. The holders 34 for rotatable reception of the saddle holder 15 at the carrier frame 8 are provided at the outer longitudinal tubes 36, while the saddle holder bar 17, which is connected via the connection frames 39, with the longitudinal tubes 36, comprises a connection bolt at 38, preferably with a cap, which can be locked and secured via a holder ring 25, or a shackle to the carrier frame 8. Correspondingly, the saddle holder frame 17 is disposed slightly above the longitudinal tubes 36, which form a plane.

The longitudinal tubes 36 are connected amongst each other through the lateral connector tube 37 and connected to the saddle holder frame 17 through the connection spout 50.

The saddle holder frame 17 is provided slightly bent, so that its end, which is remote from the carrier frame 8, and connected with the longitudinal tubes 36 via the connections frames 39, can be run upwards and is further removed from the plane of the longitudinal tubes 36, than the end at the side of the carrier frame.

As it is apparent in particular from FIG. 2, the connection frames 39 establish a triangle, which is open at the bottom, wherein a bar is provided in the plane of the longitudinal tubes 36, which functions as a saddle blanket holder 16, and which is disposed at the lateral connection tube 37, or at the connection spout 50.

At the carrier frame 8, at the upper end at the main frames 19, two grips 32 are provide as tubular spouts with rubber caps, or other covers suitable for a grip. The grips 32 are similar to the bent frames 27, run out in a laterally protruding manner from the plane of the main frames 19.

An additional grip 26 is also formed through providing a rubbery material at the uppermost lateral tube 33.

At the bent tubular frame 27, two curved hooks are provided as halter or bridle holder 28, which are offset from each other.

The halter and the bridle, which are received by the halter and bridle holder 28, can be secured via a rubber band, which is not shown, which can be hooked into the rings, which are disposed on the carrier frame 8. Furthermore, a rope, a chain, or a rubber band 30 can be provided in the rings 29, in order to hold the halter hanging downward in the direction of the carrier frame 8, so that it does not get into the way, when the saddle cart is pushed.

At the carrier frame 8 at the lower end of the main frames 19, a respective long nut and bolts with counter nuts 10 are provided, which abut to the ground supports 11 in the unfolded drivable state of the saddle cart. Through adjustment of the bolts, the distance of the lower end of the ground supports 11, with reference to the lower frame component 43, or to the lateral beam 48, on which the long nuts 9 are provided, can be adjusted. This is advantageous, since at the ears 18, which are provided at the axle housing 47, offset from each other (FIG. 3), a rotatable locking frame 13 with a lock plate 51 is provided, which works together with a locking axle 12, which is provided between the ground supports 11. As can be derived in particular from FIG. 1, the locking frame 13 is pivoted downwards through the rotating connections 53, similar to the rotating connections 44, as well as through the rotating connections for the saddle holder, provided at the holders 34, which are provided on the holders 18, when the carrier frame 8 is in a vertical position, so that the locking plate 51 can reach behind the locking axle 12, and locks with it through friction. Through the setting of the distance of the ground supports 11, relative to the lateral beam 48 of the lower component 43, the clamping of the locking plate 51 with the locking axle 12 can be adjusted. Through the curved shape of the locking frame 13, it can be operated by hand, and also by foot. Through the locking frame 13, thus the raised position of the carrier frame 8, relative to the lower frame part 43, is secured and locked.

The ground supports 11 have rubber caps 21 at their respective ends or protective caps made from another suitable material, so that the saddle cart in a folded state, as can be seen in FIG. 3, can also be stored in upright position, wherein the equipment basket is then tilted by up to 90°, relative to the depiction in FIGS. 1 through 3.

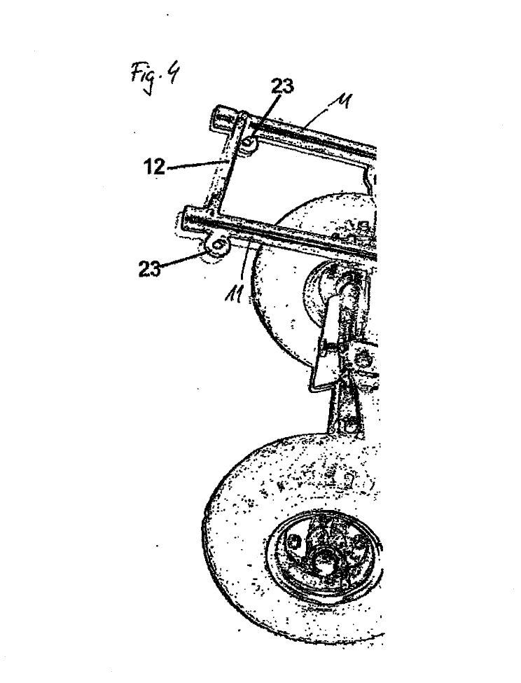

FIG. 4 shows the ground supports 11 in more detail, on which support rings are provided close to the lock axle 12 for abutment to the lower frame section 43, or the equipment basket 1.

As can be seen from FIG. 1, a bolt 14 is provided at the connection rod 49 within the equipment basket 1, which enables the locking of the saddle cart in folded state, through clamping the carrier frame 8, or the saddle holder 15. The locking can be disengaged through a respective elastic deformation of the bolt 14 or the connection rod 49 and/or the saddle holder 15.

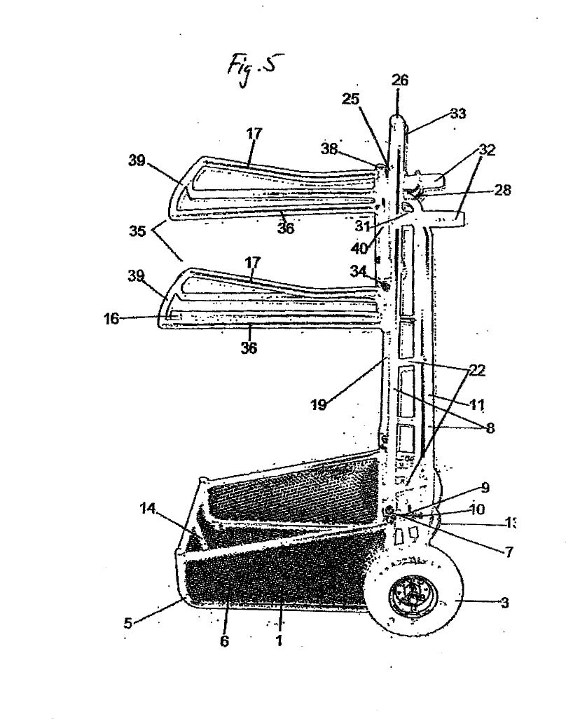

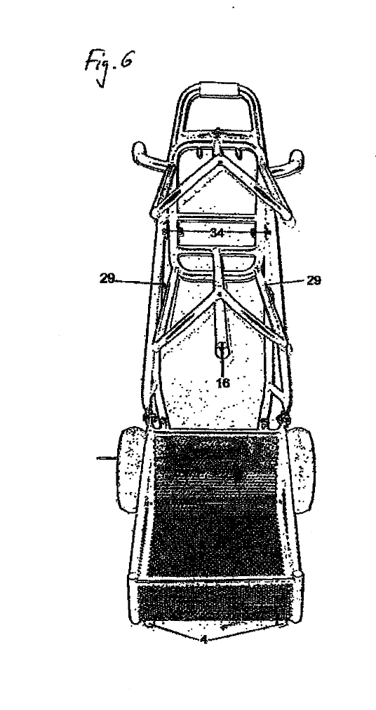

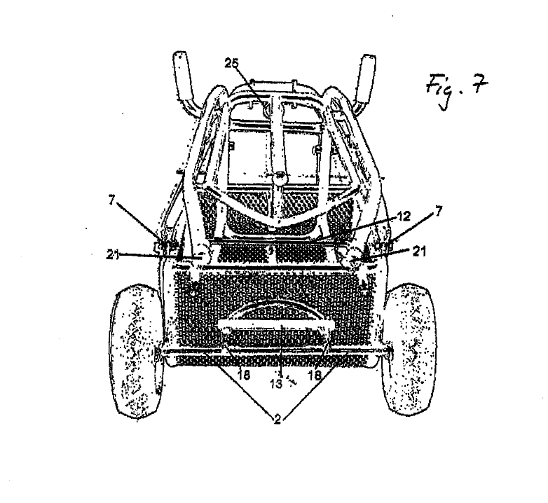

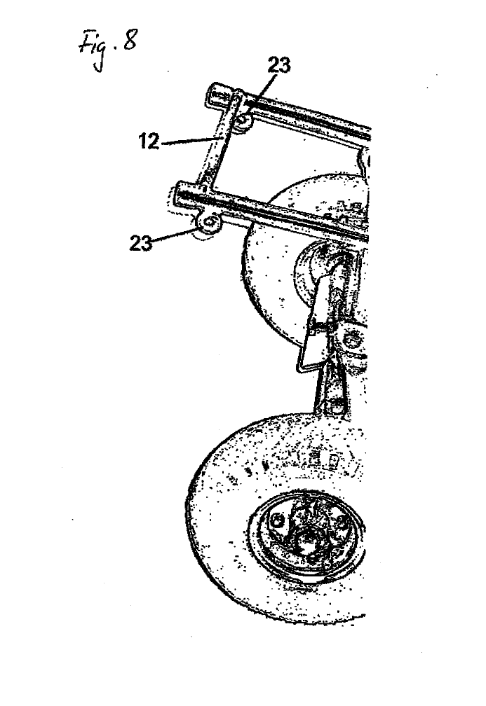

FIGS. 5 through 8 show a further preferred embodiment of a saddle cart according to the invention, in which the same elements or components are associated with the same designations. The most important difference of the embodiment of FIGS. 5 through 8 is that instead of a saddle holder a double saddle holder 35 is provided, in which two single saddle holders are connected amongst each other via a rectangular tubular frame 40, which is pivotably attached at the carrier frame 8 or the main frames 19, through a respective holder 34. Through providing parallel aligned and spaced saddle holder frames 17, as well as longitudinal tubes 36, and saddle blanket holders 16, the carrier frame 8 has to be slightly adapted, in order to create enough space, so that the double saddle holder 35 can be received in the equipment basket 1, and in the trapezoid frame of the carrier frame 8. For this purpose, the main frames 19 and the ground support 11 are spaced further apart, which is accomplished through a stronger curved tubular spout 31 in the upper section of the carrier frame 8. This way, the space between the ground supports 11 and the bottom of the equipment basket 1 is expanded in the folded state, so that the double saddle holder 35 can be received therein (re: FIG. 7).

Besides that, the embodiment of FIGS. 5 through 8 does not differ from the embodiment of FIGS. 1 through 4, so that a repetition of the identical description is dispensed with.

Both preferred embodiments shown are foldable saddle carts. However, the present inventions comprises saddle carts that cannot be folded, since they are e.g. intended for a stationary stable use, and unlike tournament saddle carts, do not have to be transported. In these saddle carts, the design can be varied in a manner, so that no rotating joints 44, 52, and 53 are provided, but the respective parts are connected in a rigid manner. This can be accomplished e.g. through welded joints.

The shown saddle carts can be manufactured from any suitable material, in particular steel, and in particular stainless steel, wherein also the perforated sheet 16 can be made from stainless steel.

Through the exhibited design of the foldable saddle cart, simple handling is assured, wherein only the carrier frame 8 has to be raised in order to set up the saddle cart, which can be performed in a simple manner by using the saddle blanket holder 16 as a grip, in order to disengage the carrier frame 8 from the locking through the bolt 14 and raising it into the vertical position.

The carrier frame 8 can be locked in the upright position through folding the lock frame 13 and clamping the lock plate 51 with the lock axle 12, whereby the carrier frame 8 is secured in its vertical position. Subsequently, the saddle holder 15 or the double saddle holder 35 is brought into a horizontal position through pivoting and they are secured through the bolt 18 and the safety ring 25, or the shackle. In this position, the saddle cart is completely set up, and can be loaded with the equipment in the equipment basket 1, the saddle blanket on the saddle blanket holder 16, and with the saddle on the saddle holder 15, or the double saddle holder 35. Additionally, the halter and the bridle can be inserted at the halter- and bridle holder 28 and can be secured via a rope, a chain or a rubber band 30.

The present invention thereby characterized in particular through providing a comfortable transportation means for saddles and equestrian equipment in riding and tournament operations, suitable for English, Western, and recreational riding. The functionality and the driving comfort of the saddle cart in combination with a modern varied design facilitate the individualism of the rider and his identification with the equestrian sport, so that the attraction of the equestrian sport is additionally improved.

According to the present preferred embodiment both wheels can have air inflated or solid rubber tires. The standard tires correspond to the norm 3.00/4. For functionality reasons, larger and smaller tire sizes are possible. The equipment basket simultaneously also serves as a support in the standing, unfolded state. It is framed by a 59 cm long, 42 cm wide, and 17 cm (front) or 25 cm (rear) high tubular frame, and includes, among other things, two rubber stops at the side opposite to the wheels. The bottom and lateral parts are made from perforated, easy to clean stainless steel sheets. The main carrier frame (in the unfolded position) is formed by a 9.5 cm long, 42 cm wide, and 103 cm tall longitudinal tubular frame with lateral connections and an arresting frame disposed transversal to the wheel axle, locking with the outer tube of the wheel axle, depending on the load, during locking operations, thereby, providing a dynamic adaptation and an increase in stability, depending on the different loads. The locking frame relative to the carrier frame can be adjusted through two locking screws, without clearance, for a further increase in transportation stability. The grips in the upper section of the main carrier frame (two opposing grips, one grip at the very top) allow an operation of the saddle cart with one hand, as well as with two hands. The upper of a total of four frames of the horse blanket- and saddle holder is formed so that the center of gravity of the saddle is oriented towards the main carrier frame. The horse blanket is placed over the lower frame, which is open from the front (horse blanket rod).

Each saddle cart is outfitted with its own recordable production number, which is applied e.g. through laser printing at a suitable location. Furthermore, a respective suitable device for replaceable individually designed name plates is mounted. The saddle carts can also be produced with the additional function of a trailer, e.g. for quads. According to requirements, the saddle carts can be manufactured in various colors, coatings (e.g. powder coating), and degrees of luster (e.g. matte or shining). An advantageous property of a saddle cart is also its universal usability, not only for saddles and equipment, but additionally, also for transportation of feed materials (sack or barrel), or cases with beverages.

The tubular steel frame of the saddle cart is manufactured from steel, stainless steel, high strength aluminum or titanium, (as a noble version for tournaments). Basically there are three variants of saddle carts, as a stable saddle cart (two wheels, not foldable), tournament saddle cart (two wheels, foldable), and saddle cart with four wheels for two saddles simultaneously. In the initial state, the saddle cart can be stored upright or flat. For empty transportation it is lifted at the upper handle, or at the two side handles, and raised into a respective ergonomically tilted position, depending on body position and body height, and pulled or pushed.

For transporting the saddle and the equipment, the saddle cart is set up in the following sequence: the saddle cart is placed on the ground on the two rubber stoppers of the equipment basket in horizontal position, so that it rests on both wheels and on both rubber stoppers. With one hand, the saddle blanket holder, which is disposed in the equipment basket during empty transportation, is raised up to the stop. In a further operation, the main carrier frame is brought into a vertical position up to its stop, and locked with the locking frame either via foot or via hand, so that a folding back or rolling away of the saddle cart is not possible anymore. Now the combined saddle and saddle blanket holder is brought into a horizontal position with one hand at the uppermost preformed bar up to the stop. The holding ring made from stainless material or the holding shackle is placed over the protruding locking pin with safety cap at the second lateral connection from the top and secured therewith. In case of a shackle design, the associated axle pin is screwed tight. Since the shackle version greatly protects the material and the paint, it is more abrasion resistant and thus also more durable at this location. Via the bridle and halter holder, which is located at the upper lateral tube in the middle between the grips on both sides on the side opposite to the saddle holder, now the holder and the bridle are inserted and tightened through the overreaching rubber band, in order to secure the halter and the bridle against sliding off. The link chain in the center of the two support tubes of the main carrier frame, which can also be provided as a band or rope from various materials, is placed from the outside around the holder and the bridle, and thus avoids a cumbersome hanging down of the halter and the bridle. In the equipment basket the following equipment and items can be stored, as e.g. a complete cleaning kit, riding and transport gators, horse care products, and cool down blankets (horse blankets). Eventually the saddle blanket is placed over the lower frame of the combined saddle blanket and saddle holder, which is open at the front. The saddle is now placed from the top onto the preformed and sliding inhibited saddle holder. During transportation, the saddle cart can be pulled or pushed, using the weight distribution, which is ergonomically most comfortable. A falling off of the saddle is not possible in this position, as well as in steeper positions.

Thus, the saddle cart is characterized in particular by:
A drivable, collapsible saddle cart for storing and transporting horseback riding saddles, riding- and care equipment for horses, characterized in that it constitutes a sturdy, versatile, and comfortable piece of equipment through its stable tubular frame in combination with the large equipment basket.
A saddle cart, characterized in that two wheels (3) with air inflated tires are located on the left side, and on the right side of the equipment basket (1), on which the roll axle (2) is mounted.
A saddle cart, characterized in that at the front part of the equipment basket (1) rubber stoppers (4) are disposed on the right side and on the left side respectively.
A saddle cart, characterized in that the wheels (3) and rubber stoppers (4) are planted on the ground, when the loaded saddle cart is parked, providing very strong standing stability and resistance against tipping and a strong safety against sliding during loading and unloading.
A saddle cart, characterized in that the tubular frame (5) is protected against wear and abrasion since it does not touch the ground, when it is being driven nor when it is parked.
A saddle cart, characterized in that the welded and perforated sheet of stainless steel (6) in the equipment basket (1) prevents against larger accumulations of debris in the equipment basket (1) and accomplishes weight savings compared to conventional sheets, and contributes to the further stiffening of the tubular frame (5).
A saddle cart, characterized in that two long nuts (9) are connected through welding at the rear lateral tube of the equipment basket (1) between the perforated mounting ears (7) for the carrier frame (8) which can be continuously adjusted through the bolts and the counter nuts (10), relative to the ground supports (11), so that thereby the locking axle (12) of the carrier frame (8) in the locking frame (13) is being put under load.
A saddle cart, characterized in that a short bolt (14) is disposed in the middle at the front lateral tube of the equipment basket (1), which protrudes into the equipment basket (1) at a slanted angle, and which engages at the rear part of the saddle holder frame (17), when folding down the carrier frame (8) together with the saddle holder (15) into equipment basket (1) after releasing the saddle blanket holder (16).
A saddle cart, characterized in that the locking frame (13) which is disposed at the roll axle (2), holds the carrier frame (8) in a vertical position.
A saddle cart, characterized in that two perforated ears (18) are mounted to the roll axle (2), at which the locking frame (13) is mounted with 2 bolts, and can thus be moved up and down.
A saddle cart, characterized in that due to the width of the locking bar (13) a twisting and torqueing of the carrier frame (8) is avoided.
A saddle cart, characterized in that the locking frame (13) is also simultaneously used for tilting the saddle cart for driving operations; thus the locking frame (13) is pressed into the locking position by foot, whereby safety is increased, since it engages in a solid manner.
A saddle cart, characterized in that the locking frame (13) can be used for lifting the saddle cart during loading and unloading, e.g. into a car, since the locking frame (13) is also provided as a holding grip. This unique locking mechanism with its various functions constitutes one of the most important features of the saddle cart.
A saddle cart, characterized in that the carrier frame (8) at the main frame (19) is squeezed flat at the lower end, drilled and mounted to the perforated mounting ears (7) at the equipment basket (1) with two bolts.
A saddle cart, characterized in that the carrier frame (8) can be folded up and down from vertical to horizontal to each respective end stop. The vertical limitation when folding up is formed by the two ground supports (20) behind the main frame (19), which are provided with rubber caps (21), securing the saddle cart in a vertical position against tipping after unfolding it.
A saddle cart, characterized in that the locking axle (12) disposed above the rubber caps (21) is welded solid in connection with the tubular spouts (22) inserted on the left and on the right, between the main frame (19) and the ground supports (20), thereby a substantial torsion stiffness of the carrier frame (8) is accomplished.
A saddle cart, characterized in that the support rings (23) welded above the rubber caps (21) are mounted slightly above the roll axle (2) after unfolding the saddle cart, preventing a over stretching of the carrier frame (8) relative to the equipment basket (1), when the load is too heavy.
A saddle cart, characterized in that in the upper part of the carrier frame (8) between the beams of the main frame (19) a lateral tube (24) is disposed, at which a metal ring or shackle (25) is mounted in the middle, which can be folded back and forth, and which serves as a lock for securing the saddle holder (15). This lateral tube (24) is thus disposed exactly at the elevation of the saddle holder frame (17)
A saddle cart, characterized in that between the lateral tube (24) and the upper rubber handle (26) a tubular frame (27) is welded in, which is bent backward in a round manner, at which two halter and bridle holders (28) are attached at the bottom. These holders are comprised of round bent rings which are open by one third, whereby a downward slide of the halters and bridles is prevented, when the saddle cart is tilted.
A saddle cart, characterized in that further help for securing the halters and bridles is provided through two rings (29) welded at the middle of the main frame (19), between which the halter and the bridle are hanging. A link chain or a rubber band (30) can be pulled across and secured and hooked into the two rings (29) on the left and on the right.
This additionally avoids that the halters and the bridles hang backward during driving operations, which would be a hindrance when walking.

A saddle cart, characterized in that above the lateral tube (24) at the main frame, on the left, and on the right, on the outside two tubular spouts are welded which are bent backwards, which are covered with rubber grips (32), and which serve as grips for driving in an unfolded state.
A saddle cart, characterized in that the upper most lateral tube (33) is covered with a rubber grip (26) at the main frame (19), and serves as a handle for pulling in the unfolded state.
A saddle cart, characterized in that on the left, and on the right, below the lateral tube (24) perforated holders (34) for receiving the saddle holder (15) are welded.
A saddle cart, characterized in that the saddle holder is provided as a single saddle holder (15) or a double saddle holder (35).
A saddle cart, characterized in that the single saddle holder (15) is mounted at the perforated holders (34) of the main frame (19), to which predrilled long ears (36) are mounted on the left and on the right, respectively, with two bolts, and which can be pivoted up and down.
A saddle cart, characterized in that shortly behind the bore holes at the long ears (36) a lateral connection tube (37) is mounted. Above that, in the middle, the saddle holder frame (17) is located, which avoids a sliding of the saddle.
A saddle cart, characterized in that at the rear end of the saddle holder frame (17) a bolt with a cap (38) is disposed, in which the metal ring or the shackle safety (25) safely engage, securing the saddle holder (15) horizontally.
A saddle cart, characterized in that at the front part of the saddle holder two connection frames (39) from the longitudinal ears (36) to the saddle holder frame (17) are welded in, so that the saddle holder (15) forms a triangle, which is open at the bottom, thus reaching very high strength.
A saddle cart, characterized in that in the middle at the lateral connection tube (37) at the elevation of the longitudinal tubes (36) the saddle blanket holder (16) is mounted, which simultaneously serves as a handle, when folding and unfolding the saddle cart
A saddle cart, characterized in that the double saddle holder (35) has the same saddle supports as the single saddle holder (15). These saddle supports are mounted on top of each other on a rectangular tubular frame (40). The rectangular tubular frame (40) has two boreholes, which are mounted at the perforated holder (34) of the main frame (19) through two bolts. At the upper side of the rectangular tubular frame (40) a bolt with a cap (38) is disposed, which is secured though a metal ring or a shackle (25). At the lower part of the rectangular tubular frame (40) the saddle blanket holder (16) is disposed. The single saddle holder (15), as well as the double saddle holder (35), are completely identical in their function.

### DESIGNATIONS

1 Equipment basket
2 Drive axle
3 Wheels
4 Rubber stopper
5 Tubular frame
6 Stainless steel perforated sheet
7 Mounting ears, perforated
8 Carrier frame
9 Long nuts
10 Bolts with counter nuts
11=20 Ground supports
12 Locking axle
13 Locking frame
14 Bolt, short
15 Saddle holder/single saddle holder
16 Saddle blanket holder
17 Saddle holder frame
18 Ears, perforated
19 Main frame
20=11 Ground supports
21 Rubber caps
22 Tubular spout
23 Support rings
24 Lateral tube
25 Metal ring/shackle
26 Upper rubber holding grip
27 Tubular frame, bent
28 Halter- and bridle holder
29 Rings
30 Link chain or rubber band
31 Tubular spout, bent
32 Rubber handles
33 Uppermost lateral tube
34 Holders, perforated
35 Double saddle holder
36 Longitudinal tubes
37 Lateral connection tube
38 Bolt with cap
39 Connection frame
40 Rectangular tubular frame
41 Frame
42 Main component
43 Lower frame section/lower section
44, 52, 53 Rotating joints
45 Tubular sections
46 Basket carrier
47 Axle housing
48 Lateral beam
49 Connection rods
50 Connection spout
51 Locking plate

1. A drivable saddle cart for storing and transporting saddles, bridles and/or other equestrian equipment, comprising:
a drivable frame including at least one saddle holder and at least two wheels.

2. A saddle cart according to claim 1, wherein the frame includes at least one support forming a support plane together with the at least two wheels.

3. A saddle cart according to claim 2, wherein at least one of the at least two wheels is provided at the support.

4. A saddle cart according to claim 1, further comprising an axle connecting the at least two wheels, and wherein the frame comprises a main component, which extends from the axle, substantially vertically upward when the saddle cart is in a drivable state, wherein the saddle holder extends from the main component, and is constructed and arranged to force a saddle stored on the saddle holder in the direction towards the main component.

5. A saddle cart according to claim 4, further comprising at least one additional saddle holder, wherein the at least one saddle holder and at least one additional saddle holder are disposed parallel to each other on the frame.

6. A saddle cart according to claim 1, wherein the frame includes an equipment container for receiving equipment.

7. A saddle cart according to claim 6, further comprising an axle connecting the at least two wheels, and wherein the frame comprises a main component, which extends from the axle, substantially vertically upward when the saddle cart is in a drivable state, wherein the equipment container has a tub shape and is disposed adjacent the at least two wheels.

8. A saddle cart according to claim 1, further comprising an axle connecting the at least two wheels, and wherein the frame comprises a main component, which extends from the axle, substantially vertically upward when the saddle cart is in a drivable state, wherein the main component has a lower end coupled to the axle and an upper end, and comprises at least one handle coupled to the upper end, wherein the handle extends substantially perpendicular to the main component.

9. A saddle cart according to claim 7, wherein the frame is collapsible, wherein the main component includes a pivot axis, at which the main component is divided into a first upper frame section, and a second lower frame section, wherein the first frame section and the second frame section are pivotable relative to each other along a pivot axis, and wherein the pivot axis is disposed between the equipment container and the saddle holder.

10. A saddle cart according to claim 9, wherein the at least one saddle holder is disposed at least one of pivotable and removable at the frame, wherein the at least one saddle holder is pivotable from a first position for receiving a saddle into a second position.

11. A saddle cart according to claim 1, wherein the frame comprises a tubular frame construction.

12. A saddle cart according to claim 7, wherein the equipment container is at least one of removably pivotably disposed at the main component.

13. A saddle cart according to claim 1, wherein the saddle holder comprises a frame construction, which comprises three rods disposed adjacent to each other, the three rods in combination emulating the shape of the back of a horse, wherein the rods are connected at their ends via connection frames so that they form a triangle open at a bottom of the triangle, wherein an additional rod configured to receive at least one of saddle blankets horse blankets is disposed integrated into the saddle holder.

14. A saddle cart according to claim 2, wherein the frame includes two supports.

15. A saddle cart according to claim 5, wherein the at least one saddle holder and at least one additional saddle holder are disposed above one another on the main component.

16. A saddle cart according to claim 7, wherein the equipment container is disposed parallel to the saddle holder.

17. A saddle cart according to claim 16, wherein the equipment container is disposed between the at least two wheels.

18. A saddle cart according to claim 16, wherein the equipment container forms the support and is provided with an elastic, slip inhibiting surface.

19. A saddle cart according to claim 18, wherein the support comprises two supports formed as feet.

20. A saddle cart according to claim 8, wherein the handle comprises two stick handles that extend substantially perpendicular to the main component in the opposite direction of the saddle holder.

21. A saddle cart according to claim 10, wherein the saddle holder is disposed at least one of pivotable and/or and removable at the first frame section, and wherein the second position is, parallel to at least one of the main component and the first frame section.

22. A saddle cart according claim 10, wherein at least one of the main component, the first frame section, the second frame section, the equipment container and the saddle holder comprises a tubular frame construction.

23. A saddle cart according to claim 13, wherein the additional rod is disposed in a space established by the three rods.

24. A saddle cart according to claim 13, wherein the additional rod is disposed below the three rods.

25. A saddle cart according to claim 13, wherein the additional rod is one of pivotable with respect to the saddle holder and removable from the saddle holder.
